(19) United States
(12) Patent Application Publication
(10) Pub. No.: US 2006/0048722 A1
(43) Pub. Date: Mar. 9, 2006

(54) Child harness

(76) Inventor: Lisen Elmberg, Stockholm (SE)

Correspondence Address: JACOBSON HOLMAN PLLC, 400 SEVENTH STREET N.W., SUITE 600, WASHINGTON, DC, 20004, US

(21) Appl. No.: 10/534,505

(22) PCT Filed: Nov. 13, 2003
(86) PCT No.: PCT/SE03/01757

§ 371 Date: May 11, 2005

(30) Foreign Application Priority Data
Nov. 29, 2002 (SE) 0203532-7

(51) Int. Cl. A62B 35/00

(52) U.S. Cl. 119/770

(57) ABSTRACT

A child harness (40) that includes a child carrying pouch (130) which comprises a generally flexible piece of material (13) that has side edges which define at least a part of respective leg opening (50) in the lower part of the pouch, wherein said piece of material (13) includes an elastically flexible sheet that is enclosed in a fabric casing (68, 69) that comprises a first piece of fabric (69) on one major surface of the sheet and a second piece of fabric (68) on the other major surface of the sheet, and wherein said pieces of fabric (68, 69) are sewn together to provide a seam (61). The-seam (61) is placed on one major surface of said piece of material (13) in the region of a respective leg opening (50) at a distance of at least 0.5 cm from the edge (51) of said opening.

The present invention relates to a child harness of the kind defined in the preamble of Claim 1.

The invention thus relates to a harness that includes a child carrying pouch which comprises a generally flexible piece of material that has side edges which define at least a part of a respective leg opening in the lower part of the pouch, wherein said piece of material includes an elastically flexible sheet that is encased in a fabric casing that comprises a first fabric on one major surface of the sheet and a second fabric on the other major surface of the sheet, and wherein said fabric layers are sewn together to provide a seam.

When evaluating the comfort afforded to a child by the child carrying pouch of this kind of harness, it was found that the edge of the leg opening is liable to pinch around at least part of the child's leg, particularly around its thigh. This pinching, or squeezing, effect has, in some instances, given rise to the suspicion that the blood circulation in the child's leg has been impaired.

This pinching effect may, of course, be referred generally to the fact that a major part of the load exerted by the child, i.e. its weight, is transferred to the bottom part of the pouch in the vicinity of the edge of the leg opening. However, a closer investigation into the reasons for the effects observed has shown that whilst the two fabrics are able to stretch satisfactorily and whilst the flexibility of the sheet was found to be satisfactory, it was also found that the seams between the fabric layers were located along the edge of the sheet, that is to say at half the thickness of the piece of material. We also found that the seams themselves were relatively hard and rigid with regard to their ability to stretch lengthwise. In combination with the location of the seams, the seams will therefor be pressed against and around part of the child's thigh when the child is seated normally in the pouch, with its stomach or back facing towards the piece of material.

The object of the invention is to provide a favourable solution to this problem in a technically simple and readily achievable manner.

This object is achieved either partly or completely by means of the present invention.

The invention is defined in the accompanying independent claim.

Further embodiments of the invention will be apparent from the accompanying dependent claims.

As a result of identifying the problem and its technical cause, it was possible to provide a favourable solution to the problem, either in part or in total, both from a technical and from a production aspect.

The invention is based on the concept of moving the seam on one main surface of the piece of material away from the edge of said piece to a position that is considerably distanced from the edge region of respective leg openings. The seam will preferably be located about 2 cm from the edge of said piece of material, so as provide an adequate margin that will ensure that the circumferential region of the child's leg that comes into contact with the edge of the leg opening will not be in contact with the seam.

Since the piece of material has a generally strip-like lower end portion that can be displaced longitudinally and received in an associated fitting, the seams may, of course, extend parallel with the side edges of the strip-like portion on one main surface of said part so that the seam will be distanced from the edge of its leg opening. The seams may, of course, approach the edge of the piece of material at a distance from those parts of the side edges of said piece of material that define leg openings.

The invention will now be described in more detail by way of example with reference to the accompanying drawings.

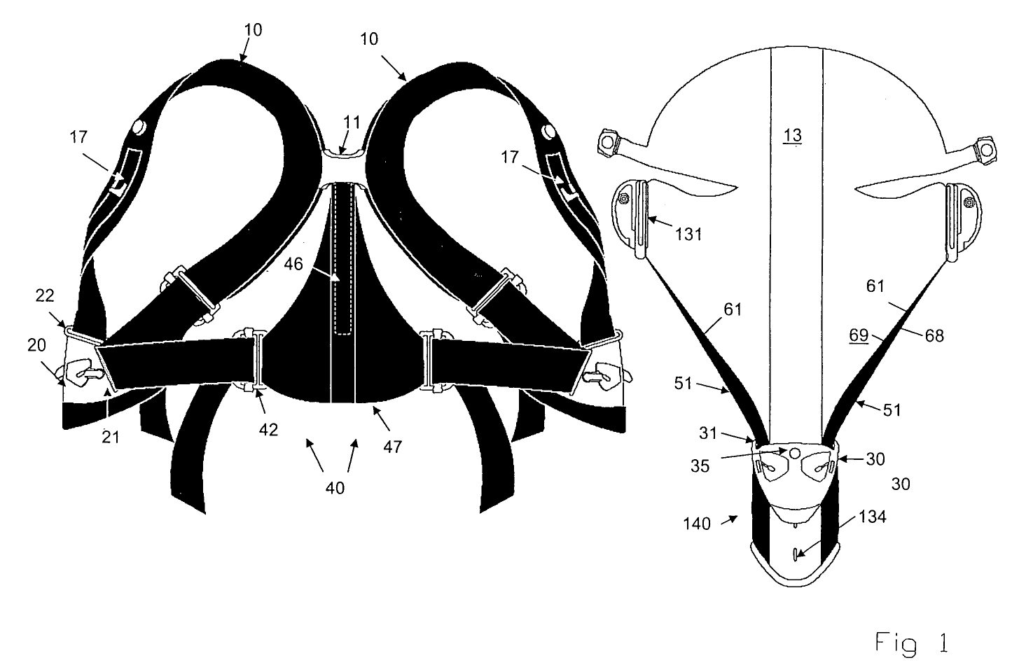

FIG. 1 is a schematic view of a child's harness as seen from the rear side of the harness, and also shows the inside of a piece of material that can be coupled to the harness to form a baby carrying pouch on the front side of the harness, that is to say on the chest side of the wearer.

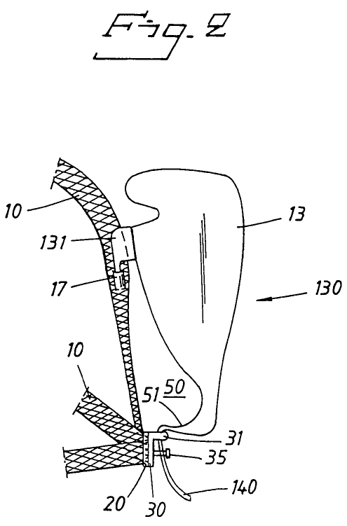

FIG. 2 is a schematic side view of a baby carrying pouch formed by the front piece and an adjacent part of the harness.

FIG. 1 shows the inside of a front piece 13 which, together with a harness 40, forms a baby carrying pouch 130 (FIG. 2) on the front side of the harness 40. The front piece 13 is thus intended to be supported by the harness 40, which includes two looped shoulder straps 10 that are mutually coupled by means of a fitting 11 on the rear side of the harness and a triangular back piece 47 which is made of flexible material and which includes a vertically extending springy and bendable stiffening 46. The loops 10 carry at their lower parts situated on the front side of the wearer a coupling element 20 which includes at its upper end an attachment 22 for one end of an associated strap loop and which has on one side thereof a fitting 21 that includes a transit opening for the other end part of said loop, this other end part extending to a length adjustment fitting 42 connected to the back piece 47. Respective elements 20 can thus be considered to form on the front side of the harness the end portions of a waist belt that includes horizontal harness parts that connect between the two elements 20.

The front piece 13 has a lower strip-like part 140 that can move lengthwise through a transit loop or eyelet 31 on an anchoring element 30. The anchoring element 30 carries a forwardly projecting pin 35, which may have an enlarged head and which can be anchored in a corresponding press stud fitting (or buttonhole) 131 in a row 134 of such elements (buttonholes) that extends along the central part of the strip-like part 140, with the intention of preventing movement of said part 140 relative to the anchoring element. The effective length of the strip-like part 140 determines the length of the front piece 13 in a vertical direction and thus also the depth of the pouch 130.

The elements 20 can be connected releasably to respective sides of the elements 30. The front piece 13 has at respective upper side portions a coupling element 131 for releasable connection with a corresponding coupling element 17 on the strap loop 10 on the front side of the harness. Each loop 10 may include a length adjustment fitting 42 for changing the size of the loop. The length of the waist strap can be changed with the aid of the adjustment fitting 42.

FIG. 1 shows the inside of the rear side of the harness (said rear side being intended to be placed on the rear side of the wearer) and also shows the front piece 13, which is intended to be carried on the front side of the harness (i.e. on the chest side of the wearer).

The front piece 13 can be considered to be formed by a generally flat piece of material that includes a flexible and springy, elastic sheet of plastic foam, where a first major surface of said sheet forms the inside of the front piece 13. The inside of the front piece 13 carries a first fabric 69 while the opposite major surface carries a second fabric 68. These pieces of fabric are joined together by a seam 61.

The seam 61 extends at a distance from the edge of the front piece 13 that defines the edge 51 of a leg opening 50 in the pouch 130 (FIG. 2). The distance between the seam 61 and said edge 51 is roughly 2 cm and the seam also extends at this distance from the edge 51 along both edge portions of the strip-like part 130. The seam 61 may extend out towards the edge part of the front piece 13, at the upper parts of said front piece 13.

As will be understood, the seam 61 may be situated on the opposite major surface of the front piece 13 at a corresponding distance from the edge of said piece of material that defines the edge 51 of the leg opening 50 of the pouch 130, particularly in the longitudinal part of said material.

1. A child harness (40) that includes a child carrying pouch (130) which comprises a generally flexible piece of material (13) that has side edges which define at least a part of a respective leg opening (50) in the lower part of the pouch, wherein said piece of material (13) includes an elastically flexible sheet that is enclosed in a fabric casing (68, 69) that comprises a first piece of fabric (69) on one major surface of the sheet and a second piece of fabric (68) on the other major surface of the sheet, and wherein said pieces of fabric are sewn together to provide a seam (61), characterised in that the seam (61) is placed on one major surface of said piece of material (13) in the region of a respective leg opening (50) at a distance of at least 0.5 cm from the edge (51) of said leg opening.

2. A child harness according to claim 1, characterised in that the seam (61) is located at a distance of at least 1 cm from the edge of said leg opening.

3. A child harness according to claim 1 or 2, characterised in that the piece of material (13) includes in its lower part a central strip-like portion (140) which can be displaced longitudinally and received in a coupling element (30) on the front side of the harness; and in that upper laterally situated edge parts of said piece of material are releasably connected to adjacent parts of the harness that are intended to be carried on the front side of the wearer, wherein the seam (61) extends at a distance from the edge of said piece of material also along the strip-like part (140).
